(19) United States
(12) Patent Application Publication
(10) Pub. No.: US 2022/0399602 A1
(43) Pub. Date: Dec. 15, 2022

(54) RESIN FRAME AND BATTERY MODULE

(71) Applicant: Toyota Jidosha Kabushiki Kaisha, Toyota-shi Aichi -ken (JP)

(72) Inventors: Yuta Nemoto, Okazaki-shi Aichi -ken (JP); Satoru Tada, Yamagata-shi Yamagata-ken (JP)

(73) Assignee: Toyota Jidosha Kabushiki Kaisha, Toyota-shi Aichi -ken (JP)

(21) Appl. No.: 17/739,298

(22) Filed: May 9, 2022

(30) Foreign Application Priority Data
Jun. 15, 2021 (JP) 2021-099272

(51) Int. Cl. H01M 50/209; H01M 50/258

(52) U.S. Cl. CPC H01M 50/209; H01M 50/258

(57) ABSTRACT

A resin frame in which a battery cell is held includes a positioning portion and a protruding portion. The positioning portion positions the top surface of the battery cell in the up-down direction by abutting with the top surface of the battery cell. The protruding portion is provided in a bottom portion of the resin frame. The protruding portion projects in the thickness direction of the battery cell. The protruding portion includes an inclined portion inclined from the thickness direction of the battery cell.

### CROSS-REFERENCE TO RELATED APPLICATION

This application claims priority to Japanese Patent Application No. 2021-099272 filed on Jun. 15, 2021, incorporated herein by reference in its entirety.

### BACKGROUND

1. Technical Field

This disclosure relates to a resin frame and a battery module.

2. Description of Related Art

Japanese Unexamined Patent Application Publication No. 2017-050200 (JP 2017-050200 A) describes a battery module including a plurality of battery cells arranged along a predetermined arrangement direction. The battery cells are held by cell holders made of resin. A projecting portion is provided on one of cell holders adjacent to each other. A recessed portion in which the projecting portion is placed is provided on the other one of the cell holders adjacent to each other.

### SUMMARY

According to JP 2017-050200 A, the cell holders adjacent to each other can be positioned by inserting the projecting portion into the recessed portion. However, the positions of the battery cells held by the cell holders are not determined directly, so that the positions of the battery cells may not be stable.

This disclosure proposes a resin frame and a battery module each of which can restrain a positional deviation of a battery cell.

One aspect of this disclosure proposes a resin frame in which a battery cell is held. The resin frame includes a positioning portion and a protruding portion. The positioning portion is configured to position a first surface on a first side of the battery cell by abutting with the first surface. The protruding portion is provided on a second side of the resin frame, the second side being a side opposite to the first side. The protruding portion projects in the thickness direction of the battery cell. The protruding portion includes an inclined portion inclined from the thickness direction.

One aspect of this disclosure proposes a battery module in which battery cells and resin frames configured to hold the battery cells are stacked alternately. Each of the resin frames includes a positioning portion and a protruding portion. The positioning portion is configured to position a first surface on a first side of a corresponding one of the battery cells by abutting with the first surface. The protruding portion is provided on a second side of the each of the resin frames, the second side being a side opposite to the first side. The protruding portion projects in the stacking direction of the battery cells and the resin frames. The protruding portion includes an inclined portion inclined from the stacking direction. The protruding portion interferes with a resin frame adjacent to the protruding portion in the stacking direction.

In the resin frame and the battery module configured as such, at the time when battery cells and resin frames are stacked alternately and compressed in the stacking direction, the protruding portion applies a force in a direction toward the first side to a battery cell held by a resin frame adjacent to the protruding portion. This allows the first surface of the battery cell to surely abut with the positioning portion, so that the first surface of the battery cell is positioned by the positioning portion. This accordingly makes it possible to restrain a positional deviation of the battery cell.

With the resin frame and the battery module according to this disclosure, it is possible to restrain a positional deviation of the battery cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view diagrammatically illustrating a battery module according to an embodiment;

FIG. 2 is a transparent perspective view illustrating one example of a configuration of a battery cell;

FIG. 3 is a perspective view illustrating one example of a resin frame;

FIG. 4 is a schematic view illustrating the arrangement of battery cells and resin frames at the time of stacking;

FIG. 5 is a schematic view illustrating a region V illustrated in FIG. 4 in an enlarged manner;

FIG. 6 is a schematic view illustrating the arrangement of the battery cells and the resin frames at the time of compression;

FIG. 7 is a schematic view illustrating a region VII illustrated in FIG. 6 in an enlarged manner;

FIG. 8 is a schematic view illustrating the arrangement of battery cells and resin frames at the time of stacking according to a second embodiment;

FIG. 9 is a schematic view illustrating a region IX illustrated in FIG. 8 in an enlarged manner;

FIG. 10 is a schematic view illustrating the arrangement of the battery cells and the resin frames at the time of compression according to the second embodiment;

FIG. 11 is a schematic view illustrating a region XI illustrated in FIG. 10 in an enlarged manner;

FIG. 12 is a front view of a resin frame according to a third embodiment;

FIG. 13 is a schematic view illustrating a region XIII illustrated in FIG. 12 in an enlarged manner;

FIG. 14 is a rear view of the resin frame according to the third embodiment; and

FIG. 15 is a schematic view illustrating a region XV illustrated in FIG. 14 in an enlarged manner.

### DETAILED DESCRIPTION OF EMBODIMENTS

The following describes embodiments with reference to drawings. In the following description, the same reference sign is assigned to the same component. Components having the same reference sign have the same name and the same function.

Accordingly, detailed descriptions on them are not repeated.

### First Embodiment

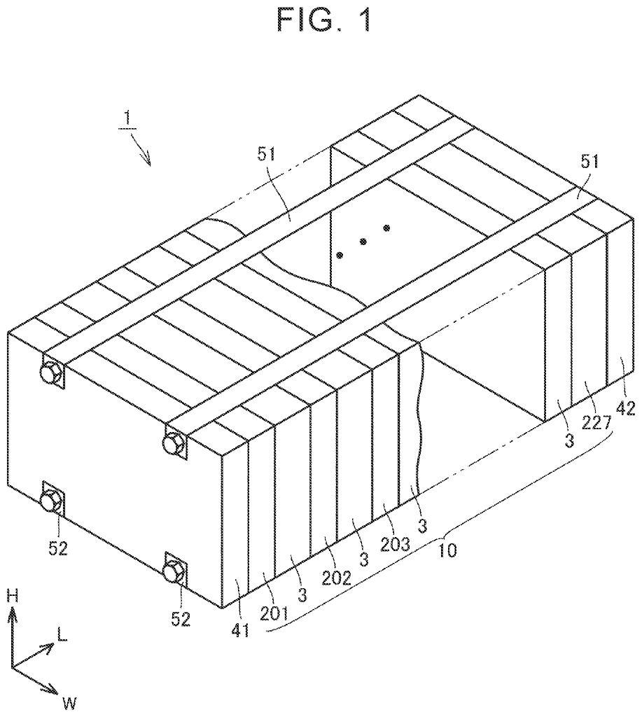

FIG. 1 is a perspective view diagrammatically illustrating a battery module 1 according to an embodiment. The number of battery cells constituting the battery module 1 is not particularly limited, but the following description deals with an example in which the number of cells is 27. As illustrated in FIG. 1, the battery module 1 includes a plurality of battery cells 201 to 227, a plurality of resin frames 3, a pair of end plates 41, 42, and a pair of restraining bands 51, 52.

In the battery module 1, the battery cells 201 to 227 and the resin frames 3 are alternately stacked, so that a stack body 10 is formed. In the following description, the height direction of the stack body 10 is indicated by H, the stacking direction of the stack body 10 is indicated by L, and the width direction of the stack body 10 is indicated by W. The height direction H is the up-down direction of the stack body 10. The stacking direction L is the longitudinal direction of the stack body 10. The width direction W is the short direction of the stack body 10.

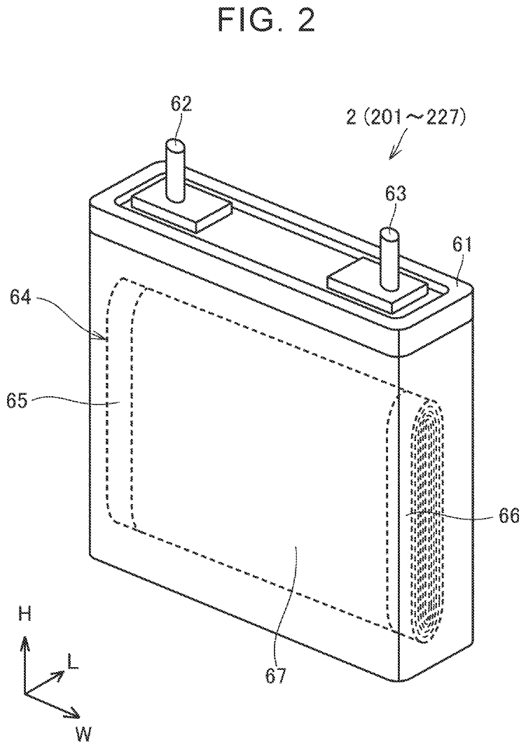

Each of the battery cells 201 to 227 is a secondary battery such as a lithium ion battery or a nickel-metal hydride battery. The battery cells 201 to 227 are configured in the same manner, and in a case where the battery cells are not distinguished from each other, they are just referred to as battery cells 2. The configuration of the battery cell 2 will be described with reference to FIG. 2.

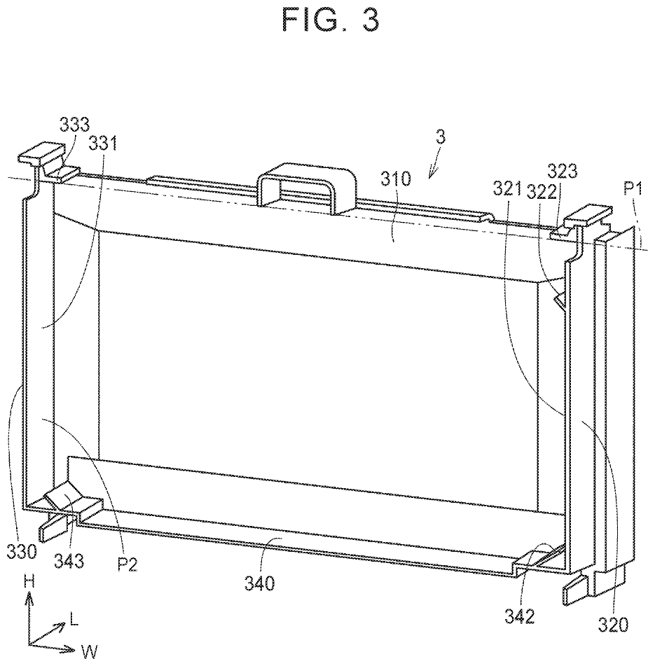

Each of the resin frames 3 is placed between two battery cells 2 adjacent to each other in the stacking direction L. As illustrated in FIG. 1, the battery cells 2 are placed at both ends of the stack body 10, and the number of the resin frames 3 is one fewer than the number of the battery cells 2. In a case where the number of the battery cells 2 included in the stack body 10 is 27, the number of the resin frames 3 is 26. A detailed structure of the resin frame 3 will be described with reference to FIG. 3.

The end plates 41, 42 are made of a metallic material, for example, and they are formed in a plate shape. The end plate 41 is placed in a first end of the stack body 10 in the stacking direction L. The end plate 42 is placed in a second end of the stack body 10 in the stacking direction L. The end plates 41, 42 are placed to sandwich the stack body 10 from both sides in the stacking direction L. An insulating member (not illustrated) is placed between each of the end plates 41, 42 and the stack body 10.

The restraining bands 51, 52 are placed on the upper side and on the lower side of the resin frames 3. The restraining bands 51 are placed on the upper side of the stack body 10, and the restraining bands 52 are placed on the lower side of the stack body 10. First end parts of the restraining bands 51, 52 are fixed to the end plate 41, and second end parts of the restraining bands 51, 52 are fixed to the end plate 42. The restraining bands 51, 52 bind (combine) the end plate 41 to the end plate 42 in a state where the stack body 10 is sandwiched between the end plates 41, 42.

FIG. 2 is a transparent perspective view illustrating one example of the configuration of the battery cell 2. As illustrated in FIG. 2, the battery cell 2 is a square-shaped cell having a generally rectangular solid shape. The stacking direction L of the stack body 10 in which the battery cells 2 and the resin frames 3 are stacked corresponds to the short direction of the battery cell 2 (the thickness direction of the battery cell 2).

An electrode body 64 is accommodated inside a case of the battery cell 2. For example, the electrode body 64 is formed such that a positive electrode 65 and a negative electrode 66 are laminated via a separator 67 and further wound cylindrically. The electrode body 64 is not limited to a winding type and may be a laminated type. The electrode body 64 is impregnated with an electrolytic solution (not illustrated).

An opening is formed on the top surface of the case of the battery cell 2. The opening is sealed by a cover 61. The cover 61 constitutes the top surface of the battery cell 2. A positive terminal 62 and a negative terminal 63 are provided in the cover 61. Respective first ends of the positive terminal 62 and the negative terminal 63 project outwardly from the cover 61. The positive terminal 62 and the negative terminal 63 project upward from the top surface of the battery cell 2. Respective second ends of the positive terminal 62 and the negative terminal 63 are electrically connected to an inner positive terminal and an inner negative terminal (not illustrated), respectively, inside the case.

Although not illustrated herein, two battery cells 2 adjacent to each other are electrically connected to each other via a bus bar. More specifically, in a case where two battery cells 2 are connected in series, the positive terminal 62 of one of the two battery cells 2 is electrically connected to the negative terminal 63 of the other one of the two battery cells 2. The bus bar is welded to the positive terminal 62 and the negative terminal 63, for example.

FIG. 3 is a perspective view illustrating one example of the resin frame 3. The resin frame 3 is made of a resin material such as polypropylene. Each of the resin frames 3 is placed between two battery cells 2 adjacent to each other and arranged in the stacking direction L and has a function to electrically insulate the two battery cells 2 from each other and to hold the positions of the two battery cells 2. Each of the resin frames 3 may further have a function to cool the battery cells 2.

As illustrated in FIG. 3, the resin frame 3 includes a main body portion 310, a pair of side wall portions 320, 330, and a bottom portion 340. The main body portion 310 has a flat plate shape. The side wall portions 320, 330 and the bottom portion 340 project from the main body portion 310 in the stacking direction L. The battery cell 2 is accommodated in a space surrounded by the main body portion 310, the side wall portions 320, 330, and the bottom portion 340, so that the battery cell 2 is held by the resin frame 3.

The side wall portion 320 has a facing surface 321 facing an accommodation space for the battery cell 2. The side wall portion 330 has a facing surface 331 facing the accommodation space for the battery cell 2. The facing surface 321 and the facing surface 331 face each other in a state where the resin frame 3 does not hold the battery cell 2 as illustrated in FIG. 3. In a state where the battery cell 2 is held by the resin frame 3, the facing surfaces 321, 331 face the battery cell 2.

A width-direction lip 322 projects from the facing surface 321 of the side wall portion 320. The facing surface 331 of the side wall portion 330 functions as a reference plane P2 configured to position the battery cell 2 in the width direction W. The width-direction lip 322 applies a force in the width direction W to the battery cell 2 held by the resin frame 3. Hereby, the battery cell 2 is pressed against the facing surface 331 (the reference plane P2), so that the battery cell 2 is positioned in the width direction W.

A pair of positioning portions 323, 333 is provided in an upper part of the resin frame 3. The positioning portions 323, 333 abut with the top surface of the battery cell 2 held by the resin frame 3 so as to position the top surface of the battery cell 2 in the height direction H. A plane extending in the stacking direction L and the width direction W and passing through the bottom surfaces of the positioning portions 323, 333 functions as a reference plane P1 configured to position the battery cell 2 in the height direction H.

Height-direction lips 342, 343 project upward from the bottom portion 340. The battery cell 2 held by the resin frame 3 is mounted on the height-direction lips 342, 343 such that the bottom surface of the battery cell 2 makes contact with the height-direction lips 342, 343. The height-direction lips 342, 343 correspond to a support portion according to this disclosure, the support portion being configured to support the bottom surface of the battery cell 2.

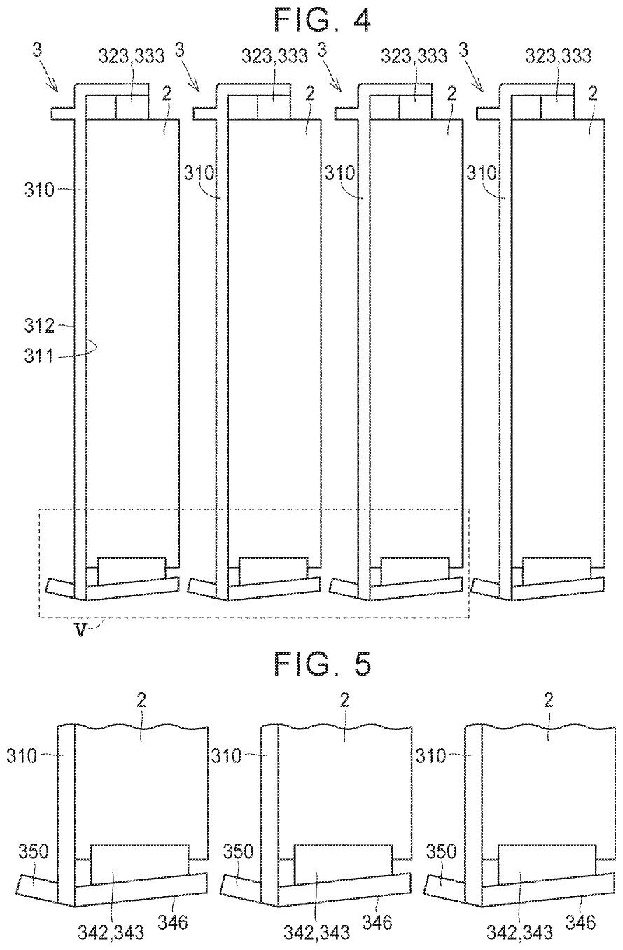

FIG. 4 is a schematic view illustrating the arrangement of the battery cells 2 and the resin frames 3 at the time of stacking. FIG. 5 is a schematic view illustrating a region V illustrated in FIG. 4 in an enlarged manner. FIG. 4 illustrates a state where four assemblies in each of which the battery cell 2 is held by the resin frame 3 are illustratively arranged in the stacking direction L, a gap is formed between the assemblies, and the assemblies are not pressurized in the stacking direction L. The main body portion 310 of the resin frame 3 has a front surface 311 facing the battery cell 2, and a back surface 312 opposite to the front surface 311. When the positioning portions 323, 333 abut with the top surface of the battery cell 2 held by the resin frame 3, the top surface of the battery cell 2 is positioned in the height direction H.

As illustrated in FIG. 5, the resin frame 3 includes a protruding portion 350. The protruding portion 350 is provided in a lower part of the resin frame 3 and projects from the back surface 312 of the main body portion 310 in the thickness direction of the battery cell 2 (in the stacking direction L, the right-left direction in FIG. 5). The protruding portion 350 extends to be inclined from the thickness direction (the stacking direction L) of the battery cell 2. In the present embodiment, the whole protruding portion 350 constitutes an inclined portion inclined from the thickness direction. The inclined portion of the present embodiment is inclined to be directed upward toward a distal end of the protruding portion 350.

An inclined surface 346 is provided below the height-direction lip 342, 343. The inclined surface 346 extends to be inclined from the thickness direction (the stacking direction L) of the battery cell 2. The inclined surface 346 of the present embodiment is inclined to be directed upward as the inclined surface 346 is distanced from the main body portion 310 of the resin frame 3.

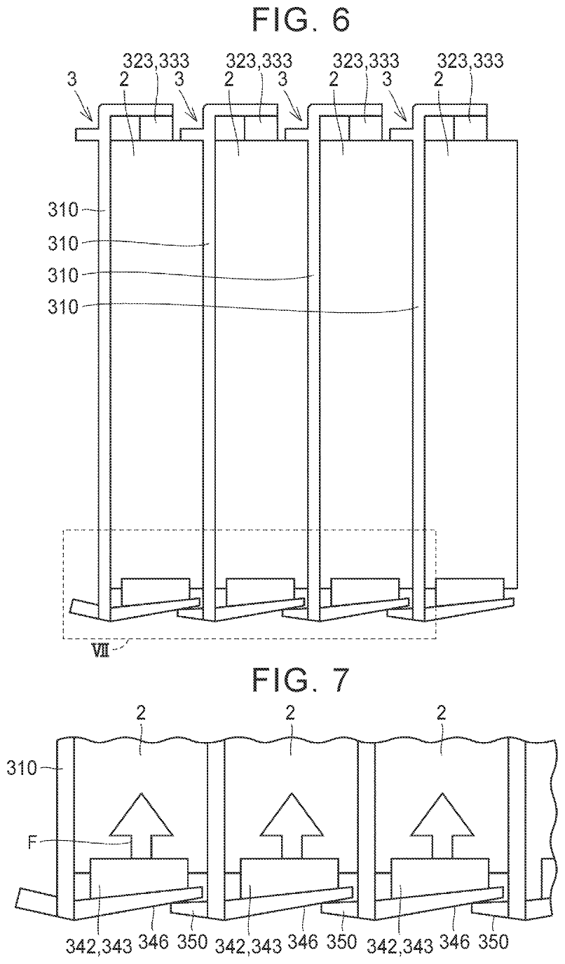

FIG. 6 is a schematic view illustrating the arrangement of the battery cells 2 and the resin frames 3 at the time of compression. FIG. 7 is a schematic view illustrating a region VII illustrated in FIG. 6 in an enlarged manner. When the stack body 10 is sandwiched between the end plates 41, 42 described with reference to FIG. 1 and the end plates 41, 42 are restricted by the restraining bands 51, 52, the assemblies in each of which the battery cell 2 is held by the resin frame 3 are pressurized in the thickness direction (the stacking direction L) of the battery cell 2. Each of the battery cells 2 makes contacts with the back surface 312 of the resin frame 3 of an assembly adjacent to the each of the battery cells 2.

The protruding portion 350 of each of the resin frames 3 interferes with its adjacent resin frame 3 in the stacking direction L. More specifically, the protruding portion 350 abuts with the inclined surface 346 of the adjacent resin frame 3. A stress from the protruding portion 350 is applied to the inclined surface 346 inclined from the stacking direction L. At the time when the stack body 10 is stacked in the stacking direction L, the protruding portion 350 applies an upward force F to the height-direction lip 342, 343 above the inclined surface 346, and further to the battery cell 2 mounted on the height-direction lip 342, 343 in a supported manner, as illustrated in FIG. 7.

Although some descriptions overlap with the description made above, the following collectively describes characteristic configurations and effects of the resin frame 3 and the battery module 1 of the embodiment.

As illustrated in FIGS. 3, 4, the resin frame 3 includes the positioning portions 323, 333 configured to position the top surface of the battery cell 2 in the height direction by abutting with the top surface of the battery cell 2. As illustrated in FIG. 5, the resin frame 3 includes the protruding portion 350 provided in the bottom portion of the resin frame 3 so as to project in the thickness direction of the battery cell 2 (in the stacking direction L of the battery cell 2 and the resin frame 3). The protruding portion 350 extends to be inclined from the thickness direction (the stacking direction L) of the battery cell 2.

In a state where the battery cells 2 and the resin frames 3 are placed alternately and stacked in the thickness direction (the stacking direction L) of the battery cells 2 as illustrated in FIGS. 4, 5, a gap is formed between the battery cell 2 and its adjacent resin frame 3. In a compression step of compressing the battery cells 2 and the resin frames 3 in the stacking direction L as illustrated in FIGS. 6, 7, the protruding portion 350 interferes with its adjacent resin frame 3 in the thickness direction (the stacking direction L) of the battery cells 2. At the time when the stack body 10 is compressed in the stacking direction L, the protruding portion 350 applies the upward force F to the battery cell 2 held by the adjacent resin frame 3.

The top surface of the battery cell 2 surely abuts with the positioning portions 323, 333, so that the top surface of the battery cell 2 is positioned to the reference plane P1 by the positioning portions 323, 333. This accordingly restrains a positional deviation of the battery cell 2 in the stack body 10 in the height direction H. Since the position of the top surface of the battery cell 2 is stable, it is possible to reduce a poor quality of the stack body 10 in a subsequent step such as a step of welding the positive terminal 62 and the negative terminal 63 so as to electrically connect the battery cells 2 adjacent to each other.

Further, since the protruding portion 350 applies the upward force F to the battery cell 2, the strength (rigidity) against a downward stress to be applied to the battery cell 2 improves. Hereby, it is possible to restrain a downward positional deviation of the battery cell 2 at the time when a downward stress is applied to the battery cell 2 in a subsequent step such as a welding step.

As illustrated in FIG. 5, the resin frame 3 further includes the height-direction lips 342, 343 and the inclined surface 346. The height-direction lips 342, 343 support the bottom surface of the battery cell 2. The inclined surface 346 is provided below the height-direction lips 342, 343. In the compression step illustrated in FIGS. 6, 7, the protruding portion 350 abuts with the inclined surface 346 of the adjacent resin frame 3 in the thickness direction (the stacking direction L) of the battery cell 2. As a component force of a force by which the protruding portion 350 presses the inclined surface 346, an upward force is caused. Hereby, the upward force F can be surely applied to the battery cell 2 held by the adjacent resin frame 3.

### Second Embodiment

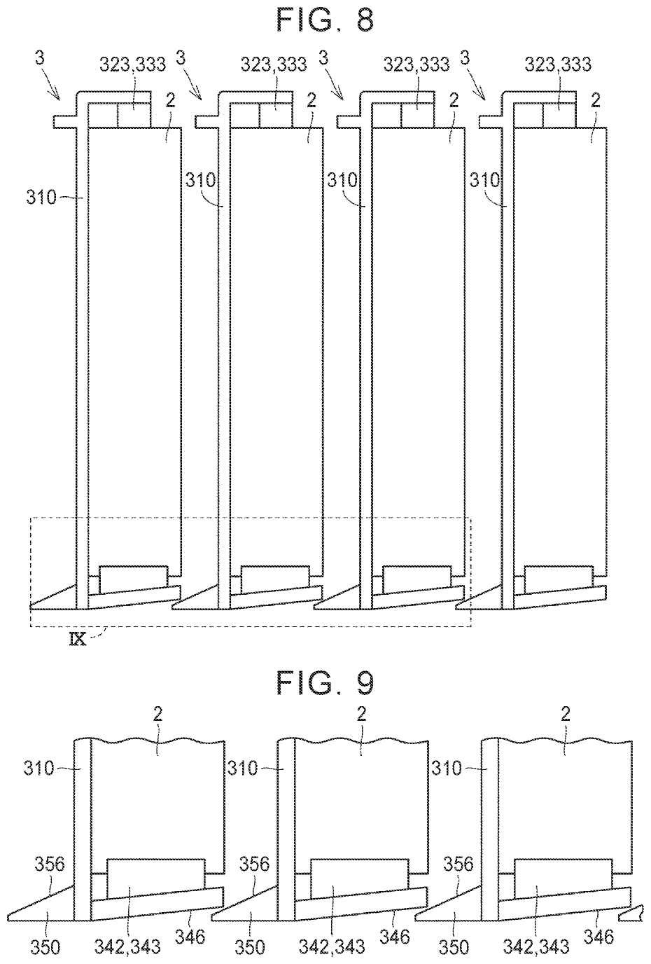

FIG. 8 is a schematic view illustrating the arrangement of the battery cells 2 and the resin frames 3 at the time of stacking, according to a second embodiment. FIG. 9 is a schematic view illustrating a region IX illustrated in FIG. 8 in an enlarged manner. The resin frame 3 of the second embodiment is different from that of the first embodiment in the shape of the protruding portion 350.

More specifically, as illustrated in FIG. 9, the top surface of the protruding portion 350 constitutes an inclined portion 356 extending to be inclined from the thickness direction (the stacking direction L) of the battery cell 2. The inclined portion 356 is inclined to be directed downward toward the distal end of the protruding portion 350. The angle at which the inclined portion 356 is inclined from the thickness direction (the stacking direction L) of the battery cell 2 is larger than the angle at which the inclined surface 346 below the battery cell 2 is inclined.

By providing a difference between the inclination angle of the inclined portion 356 and the inclination angle of the inclined surface 346, the protruding portion 350 is configured not to interfere with its adjacent resin frame 3 at the time of stacking before the stack body 10 is compressed, as illustrated in FIGS. 8, 9.

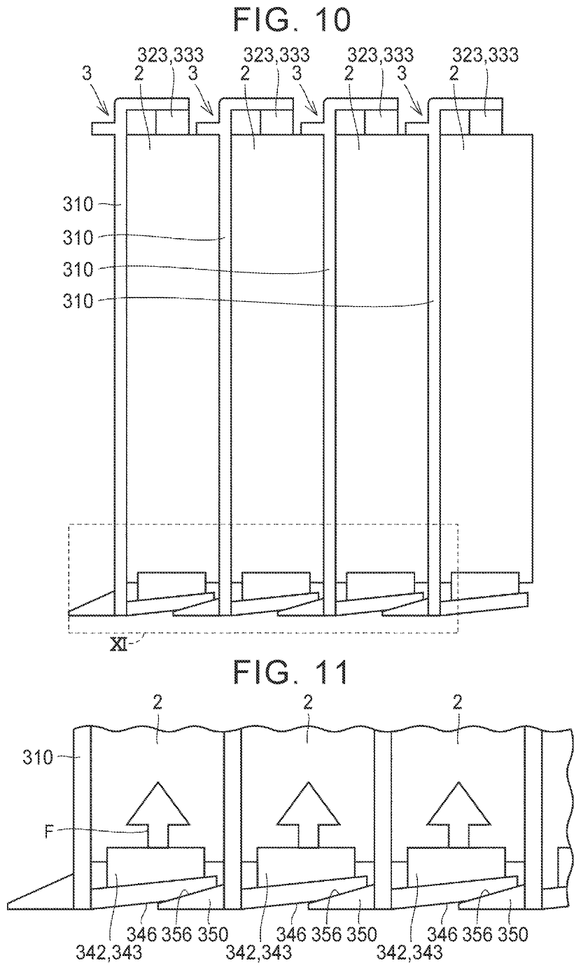

FIG. 10 is a schematic view illustrating the arrangement of the battery cells 2 and the resin frames 3 at the time of compression according to the second embodiment. FIG. 11 is a schematic view illustrating a region XI illustrated in FIG. 10 in an enlarged manner. By providing a difference between the inclination angle of the inclined portion 356 and the inclination angle of the inclined surface 346, the protruding portion 350 is introduced below the inclined surface 346 in the compression step, and as illustrated in FIG. 10, 11, the inclined portion 356 of the protruding portion 350 interferes with the inclined surface 346 of the adjacent resin frame 3.

With the resin frame 3 and the battery module 1 according to the second embodiment, it is possible to cause the protruding portion 350 to surely interfere with its adjacent resin frame 3 at the time when the stack body 10 is compressed in the stacking direction L. At this time, the protruding portion 350 applies the upward force F to the battery cell 2 held by the adjacent resin frame 3, so that the top surface of the battery cell 2 is positioned to the reference plane P1 by the positioning portions 323, 333. This accordingly makes it possible to restrain a positional deviation of the battery cell 2 in the stack body 10 in the height direction H.

In the resin frame 3 according to the second embodiment, the protruding portion 350 has a shape tapered toward its distal end. By defining the shape of the protruding portion 350, it is possible to improve moldability of the resin frame 3.

### Third Embodiment

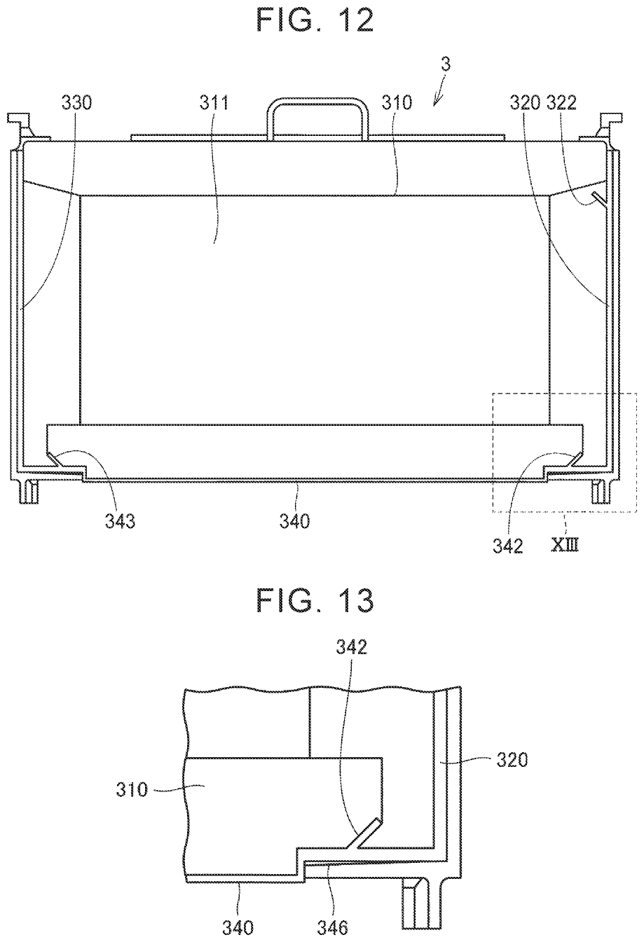

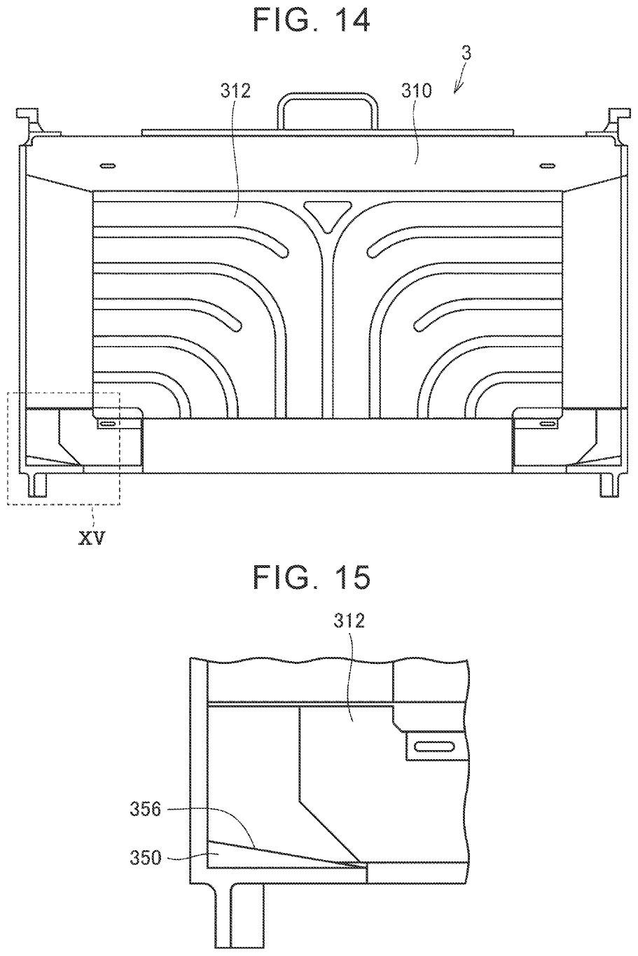

FIG. 12 is a front view of the resin frame 3 according to a third embodiment. FIG. 13 is a schematic view illustrating a region XIII illustrated in FIG. 12 in an enlarged manner. FIG. 14 is a rear view of the resin frame 3 according to the third embodiment. FIG. 15 is a schematic view illustrating a region XV illustrated in FIG. 14 in an enlarged manner. FIGS. 12, 13 illustrate the front surface 311 of the main body portion 310 of the resin frame 3, and FIGS. 14, 15 illustrate the back surface 312 of the main body portion 310 of the resin frame 3.

In the first and the second embodiments, the protruding portion 350 includes the inclined portion directed in the up-down direction as it goes toward the distal end of the protruding portion 350. On the other hand, in the third embodiment, an inclination is formed in a perpendicular direction to the thickness direction (the stacking direction L) of the battery cell 2.

More specifically, as illustrated in FIG. 13, the resin frame 3 has an inclined surface 346 below the height-direction lip 342 such that the inclined surface 346 is inclined downward as it is distanced from the side wall portion 320 of the resin frame 3 in the width direction W (the right-left direction in FIG. 13). As illustrated in FIG. 15, the resin frame 3 includes the protruding portion 350 provided in the bottom portion of the resin frame 3 so as to project to the near side in a vertical direction to the plane of paper. The protruding portion 350 includes an inclined portion 356 inclined downward as it is distanced from the side wall portion 320 of the resin frame 3 in the width direction W (the right-left direction in FIG. 15).

With the resin frame 3 and the battery module 1 according to the third embodiment having such a configuration, it is also possible to cause the protruding portion 350 to surely interfere with its adjacent resin frame 3 at the time when the stack body 10 is compressed in the stacking direction L. At this time, the protruding portion 350 applies the upward force F to the battery cell 2 held by the adjacent resin frame 3, so that the top surface of the battery cell 2 is positioned to the reference plane P1 by the positioning portions 323, 333. This accordingly makes it possible to restrain a positional deviation of the battery cell 2 in the stack body 10 in the height direction H.

A difference is provided between the inclination angle of the inclined portion 356 and the inclination angle of the inclined surface 346, and the angle at which the inclined portion 356 is inclined is larger than the angle at which the inclined surface 346 is inclined. By forming the resin frame 3 such that the inclined surface 346 and the inclined portion 356 partially overlap with each other in the height direction H, it is possible to cause the protruding portion 350 to surely interfere with the inclined surface 346 of the adjacent resin frame 3.

The descriptions of the embodiments deal with an example in which the top surface of the battery cell 2 is positioned as follows. That is, the positive terminal 62 and the negative terminal 63 project upward from the top surface of the battery cell 2, and the protruding portion 350 is provided in the bottom portion of the resin frame 3 so as to apply the upward force F to its adjacent battery cell. The upper side corresponds to a “first side” in the embodiments, and the lower side corresponds to a “second side” in the embodiments. The present disclosure is not limited to this example and may have a configuration as follows. That is, the positioning portions 323, 333 abut with any of the surfaces of the battery cell 2, the protruding portion 350 is provided on a side opposite to an abutment side where the positioning portions 323, 333 abut with the battery cell 2, and the protruding portion 350 interfering with its adjacent resin frame 3 applies, to the battery cell 2 held by the adjacent resin frame 3, a force in a direction toward the abutment side where the positioning portions 323, 333 abut with the battery cell 2. In a case where a terminal is provided on a side face of the battery cell 2, the positioning portions 323, 333 may position the side face provided with the terminal.

The embodiments have been described as above. However, it should be considered that the embodiments described herein are just examples in all respects and are not limitative. The scope of the present disclosure is shown by Claims, not by the descriptions of the above embodiments, and intended to include every modification made within the meaning and scope equivalent to Claims.

What is claimed is:

1. A resin frame in which a battery cell is held, the resin frame comprising:
a positioning portion configured to position a first surface on a first side of the battery cell by abutting with the first surface; and
a protruding portion provided on a second side of the resin frame, the second side being a side opposite to the first side, the protruding portion projecting in a thickness direction of the battery cell and including an inclined portion inclined from the thickness direction.

2. The resin frame according to claim 1, further comprising:
a support portion configured to support a second surface on the second side of the battery cell; and
an inclined surface provided further on the second side from the support portion such that the inclined surface is inclined from the thickness direction.

3. The resin frame according to claim 2, wherein an angle at which the inclined portion is inclined from the thickness direction is larger than an angle at which the inclined surface is inclined from the thickness direction.

4. The resin frame according to claim 1, wherein the inclined portion is inclined to the second side toward a distal end of the protruding portion.

5. A battery module in which battery cells and resin frames configured to hold the battery cells are stacked alternately, wherein:
each of the resin frames includes
a positioning portion configured to position a first surface on a first side of a corresponding one of the battery cells by abutting with the first surface, and
a protruding portion provided on a second side of the each of the resin frames, the second side being a side opposite to the first side, the protruding portion projecting in a stacking direction of the battery cells and the resin frames and including an inclined portion inclined from the stacking direction; and
the protruding portion interferes with a resin frame adjacent to the protruding portion in the stacking direction.

6. The battery module according to claim 5, wherein the protruding portion applies a force in a direction toward the first side to a battery cell held by the resin frame adjacent to the protruding portion in the stacking direction.

7. The battery module according to claim 5, wherein the each of the resin frames further includes
a support portion configured to support a second surface on the second side of the corresponding one of the battery cells, and
an inclined surface provided further on the second side from the support portion such that the inclined surface is inclined from the stacking direction.

8. The battery module according to claim 7, wherein an angle at which the inclined portion is inclined from the stacking direction is larger than an angle at which the inclined surface is inclined from the stacking direction.

9. The battery module according to claim 5, wherein the inclined portion is inclined to the second side toward a distal end of the protruding portion.
